(19) United States
(12) Patent Application Publication
(10) Pub. No.: US 2024/0364154 A1
(43) Pub. Date: Oct. 31, 2024

(54) ROTOR CORE AND MOTOR INCLUDING THE SAME

(71) Applicant: HL MANDO CORPORATION, Gyeonggi-do (KR)

(72) Inventor: Chungseong LEE, Gyeonggi-do (KR)

(21) Appl. No.: 18/387,674

(22) Filed: Nov. 7, 2023

(30) Foreign Application Priority Data
Apr. 28, 2023 (KR) 10-2023-0056489

(51) Int. Cl. H02K 1/276

(52) U.S. Cl. CPC H02K 1/276

(57) ABSTRACT

A rotor core comprises a rotor stack including a plurality of pole parts, each pole part having a magnet embedded hole having a magnet therein and at least one through hole located between the magnet embedded hole and an outer surface of the each pole part, thereby stably providing high output by increasing output torque and reducing torque ripples, and simplifying the process for stacking and coupling the magnet and the rotor, and reducing manufacturing costs.

### CROSS-REFERENCE TO RELATED APPLICATION

This application claims priority from Korean Patent Application No. 10-2023-0056489, filed on Apr. 28, 2023, which is hereby incorporated by reference for all purposes as if fully set forth herein.

### BACKGROUND

### Field

Some embodiments of the present disclosure generally relate to a rotor core and a motor including the same and, more specifically, a rotor core and a motor including the same, which may stably provide high output by increasing output torque and reducing torque ripples, simplify the process of stacking and coupling a magnet and a rotor, and reduce manufacturing costs.

### Description of Related Art

Typically, interior permanent magnet motors (IPMs) are used in electric vehicles and hybrid vehicles because of high efficiency and torque and output density. The IPM has a structure in which magnets are embedded in the rotor and is distinguished from a surface permanent magnet motor (SPM) in which magnets are positioned on the surface of the rotor. As compared with the SPM, the IPM has high output density, making it suitable as the driving motor of the electric vehicle. However, the IPM may generate large torque ripples. Torque ripple is the deviation of the output torque value relative to the average torque value and causes noise vibration, and harshness (NVH) that deteriorates vehicle performance.

There are various attempts to reduce the torque ripples of the IPM, including, e.g., changing the structure of the magnet placement in the rotor core or forming a recess or a hole in the surface or inside of the rotor core. However, most of the conventional attempts are not effective in practice, or are hard to apply in reality due to failure to suggest a specific shape.

Thus, a structure capable of effectively reducing torque ripples through a specific shape is required.

Meanwhile, in general, the rotor core of the motor adopts a stack structure in which electric steel plates, which are thin magnetic bodies, are stacked and fixed to enhance manufacturability. To fix the stacked stacks, mechanical fastening has conventionally been used to embossing or welding the stacks, and chemical fastening which applies an adhesive between the stacks is used. However, the mechanical fastening may deteriorate core magnetism and the permanent magnet due to a change in the shape of the rotor stack, thereby degrading motor performance. The chemical fastening cause to increase manufacturing cost.

As another approach to fix the permanent magnet to the rotor stack, a molding material may be injected after the magnet is inserted, or the magnet is press-fitted into a hole formed in the rotor stack. However, the molding method may have difficulty in adjusting the amount of molding material injected and requires a time for hardening which leads to poor producibility. The press-fitting method may damage the coating on the magnet surface or cause degradation.

Therefore, a need exists for a structure capable of coupling the magnet to the rotor core in a simple and convenient way without deteriorating motor performance.

### BRIEF SUMMARY

Conceived in the foregoing background, some embodiments of the present disclosure may relate to a rotor core and a motor including the same, which may stably provide high output by increasing output torque and reducing torque ripples, simplify the process of stacking and coupling a magnet and a rotor, and reduce manufacturing costs.

According to the present embodiments, there may be provided a rotor core, comprising a rotor stack including a plurality of pole parts having a magnet embedding hole where a magnet is embedded and at least one through hole formed between the magnet embedding hole and an outer surface.

According to the present embodiments, there may be provided a rotor core, comprising a rotor stack including a plurality of pole parts having a magnet embedding hole where a magnet is embedded and at least one through hole formed between the magnet embedding hole and an outer surface and a fixing member inserted into the through hole and axially supported by the magnet.

According to the present embodiments, there may be provided a motor comprising a rotor core, comprising a rotor stack including a plurality of pole parts having a magnet embedding hole where a magnet is embedded and at least one through hole formed between the magnet embedding hole and an outer surface or a rotor core, comprising a rotor stack including a plurality of pole parts having a magnet embedding hole where a magnet is embedded and at least one through hole formed between the magnet embedding hole and an outer surface and a fixing member inserted into the through hole and axially supported by the magnet.

According to certain embodiments of the present disclosure, it is possible to stably provide high output by increasing output torque and reducing torque ripples, simplify the process for stacking and coupling a magnet and a rotor, and reduce manufacturing costs.

### DESCRIPTION OF DRAWINGS

The above and other objects, features, and advantages of the disclosure will be more clearly understood from the following detailed description, taken in conjunction with the accompanying drawings, in which:

FIG. 1 is a plan view illustrating a portion of a rotor core and a motor according to an embodiment of the present disclosure;

FIG. 2 is a partial plan view illustrating a rotor core according to an embodiment of the present disclosure;

FIG. 3 is a partial plan view illustrating a rotor core according to an embodiment of the present disclosure;

FIG. 4 is a partial plan view illustrating a portion of a rotor core according to an embodiment of the present disclosure;

FIG. 5 is a partial plan view illustrating a rotor core according to an embodiment of the present disclosure;

FIG. 6 is a partial plan view illustrating a rotor core according to an embodiment of the present disclosure;

FIG. 7 is a partial perspective view illustrating a rotor core according to an embodiment of the present disclosure;

FIG. 8 is a partial exploded perspective view illustrating a rotor core according to an embodiment of the present disclosure;

FIG. 9 is a partial perspective view illustrating a rotor core according to an embodiment of the present disclosure;

FIG. 10 is graphs for illustrating an air gap magnetic flux density of a rotor core according to an embodiment of the present disclosure; and

FIG. 11 is graphs for illustrating an average torque and torque ripple of a motor according to an embodiment of the present disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

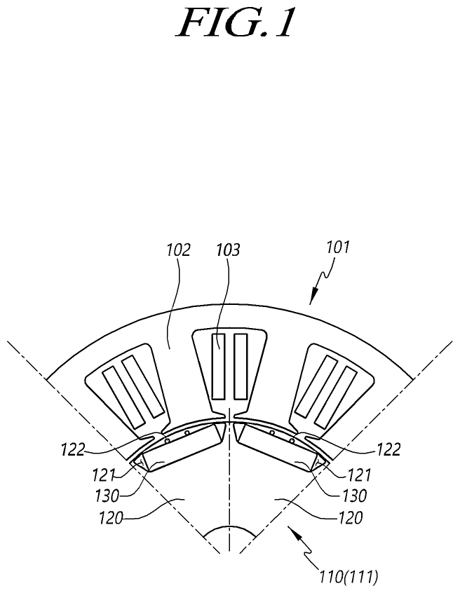

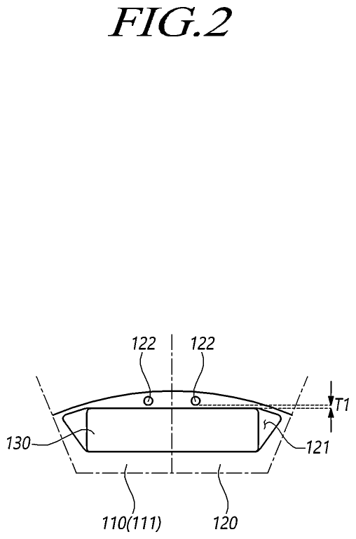

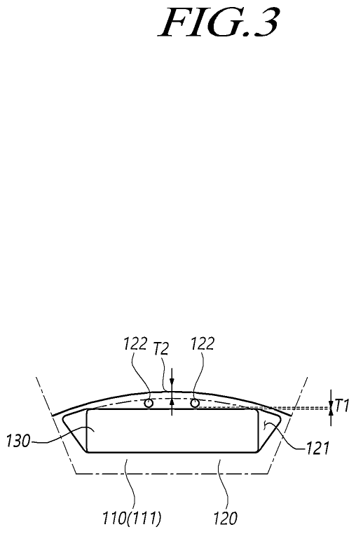

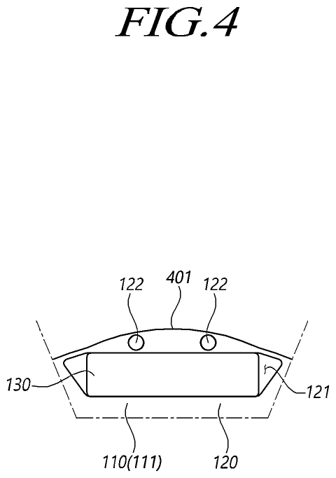

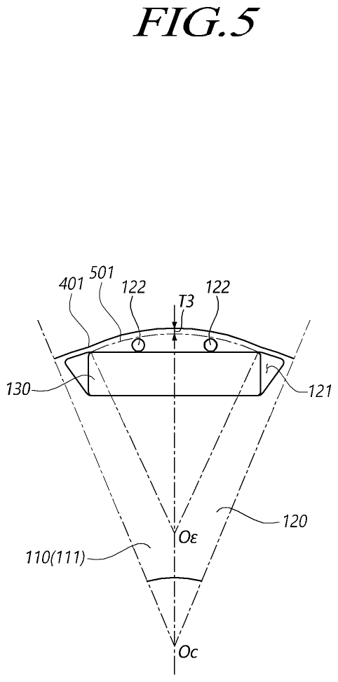

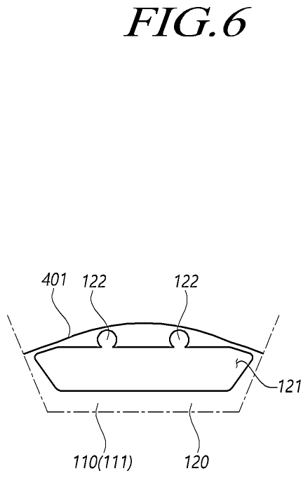

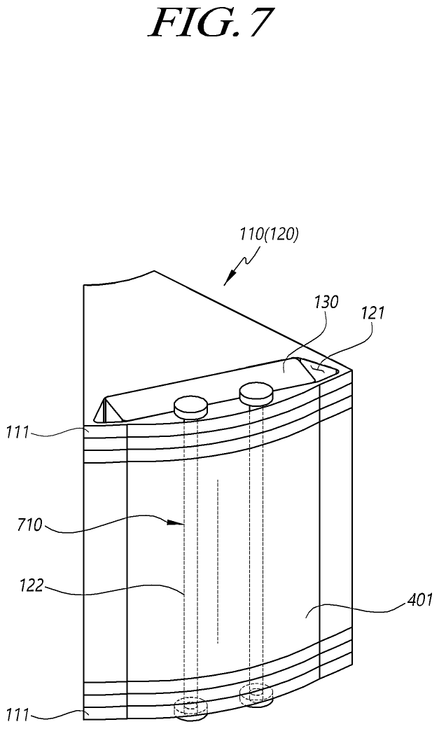

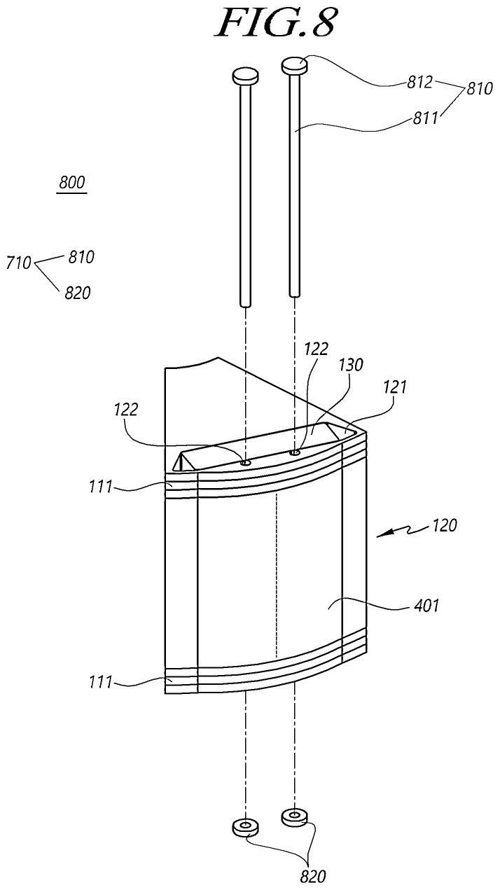

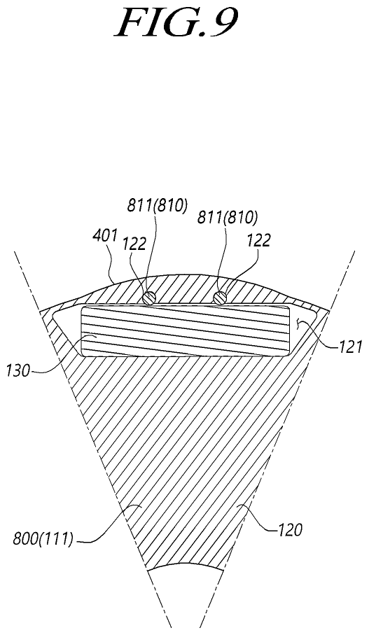

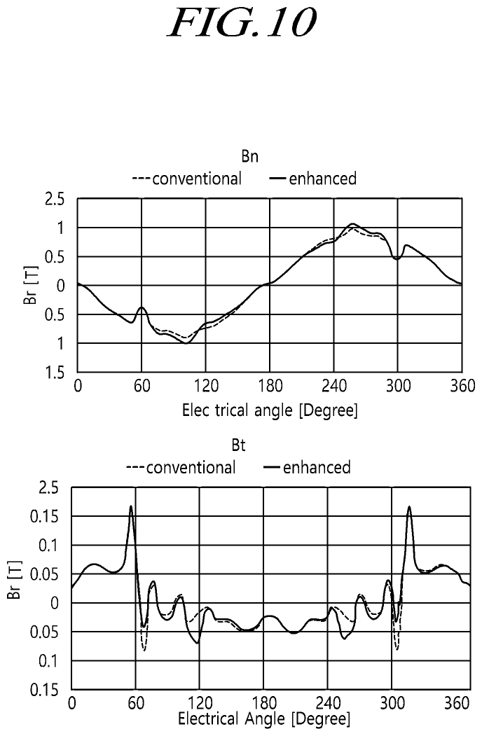

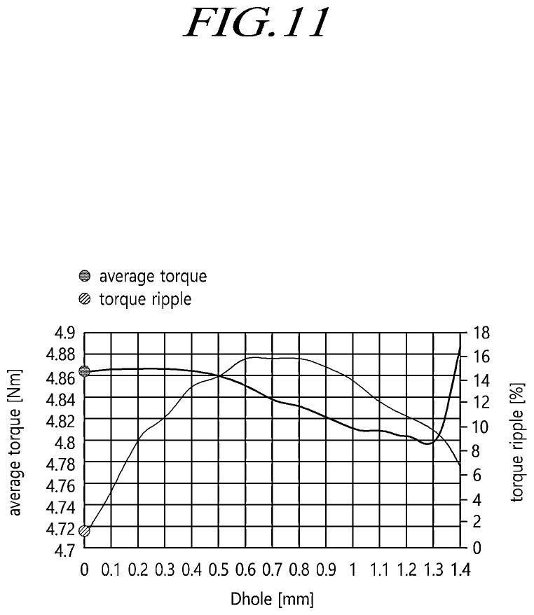

FIG. 1 is a plan view illustrating a portion of a rotor core and a motor according to an embodiment of the present disclosure. FIG. 2 is a partial plan view illustrating a rotor core according to an embodiment of the present disclosure. FIG. 3 is a partial plan view illustrating a rotor core according to an embodiment of the present disclosure. FIG. 4 is a partial plan view illustrating a portion of a rotor core according to an embodiment of the present disclosure. FIG. 5 is a partial plan view illustrating a rotor core according to an embodiment of the present disclosure. FIG. 6 is a partial plan view illustrating a rotor core according to an embodiment of the present disclosure. FIG. 7 is a partial perspective view illustrating a rotor core according to an embodiment of the present disclosure. FIG. 8 is a partial exploded perspective view illustrating a rotor core according to an embodiment of the present disclosure. FIG. 9 is a partial perspective view illustrating a rotor core according to an embodiment of the present disclosure. FIG. 10 is graphs for illustrating an air gap magnetic flux density of a rotor core according to an embodiment of the present disclosure. FIG. 11 is graphs for illustrating an average torque and torque ripple of a motor according to an embodiment of the present disclosure.

According to an embodiment of the present disclosure, a rotor core 110 may include a rotor stack 111. The rotor stack 111 may include a plurality of pole parts 120 having a magnet embedded hole 121 where one or more magnet 130s are embedded and at least one through hole 122 formed between the magnet embedded hole 121 and an outer surface of the pole part 120.

Further, according to an embodiment of the present disclosure, there may be provided a motor including the rotor core 110. For instance, a motor includes the rotor core 110, a stator core 101 receiving the rotor core 110 therein, and a rotating shaft fixedly coupled to the rotor core 110 to rotate along with the rotating core 110.

Meanwhile, according to an embodiment of the present disclosure, there may be provided the rotor core 110 and a motor including the rotor core 110, which are described below in detail.

Referring to FIG. 1, a motor according to an embodiment of the present disclosure includes a stator core 101 and a rotor core 110. The stator core 101 includes a plurality of stator teeth 102 on which a winding 103 is wound. The stator slots defined by adjacent pair of stator teeth 102 may be designed and dimensioned to receive the winding 103. The structure and shape of the stator core 101 are generally known, and therefore further detailed description thereof is not given in the present disclosure. The rotor core 110 according to an embodiment of the present disclosure includes a rotor stack 111. A plurality of rotor stacks 111 are stacked to form the rotor core 110 (see FIG. 7). The rotor stack 111 includes a plurality of pole parts 120. The plurality of pole parts 120 are arranged along the circumferential direction, and magnets 130 are arranged in the magnet embedded holes 121 formed in the respective pole parts 120, with N poles and S poles alternating along the circumferential direction. The rotor core 110 according to an embodiment of the present disclosure may have, for example, but not limited to, six poles or eight poles. The drawings illustrate only two pole parts 120 among the plurality of poles and an embodiment of the present disclosure in which one pole part 120 has a central angle of 45 degrees, although not limited thereto.

Each pole part 120 has a magnet embedded hole 121 and at least one through hole 122. As shown in the drawings, the magnet embedded hole 121 may be formed at the radial outer portion of the pole part 120, and the magnet 130 is inserted into the magnet embedded hole 121. The rotor core 110 according to an embodiment of the present disclosure may further include a fixing member 170 for fixing the magnet 130 inserted in the magnet embedded hole 121. The fixing member 170 will be described below in detail.

The through hole 122 is formed between the magnet embedded hole 121 and the outer surface of the pole part 120. For instance, the outer surface of the rotor core 110, which is formed as the outer surface of the plurality of pole parts 120, may be formed to be coaxial with the central axis of the rotor core 110 with a constant curvature. Alternatively, as described below in detail, a protrusion 401 may be formed on the outer surface of the pole part 120. The through hole 122 may be formed between the magnet embedded hole 121 and the outer surface of the pole part 120 having a constant curvature or the outer surface of the pole part 120 formed by the protrusion 401.

As the through hole 122 is formed between the magnet embedded hole 121 and the outer surface of the pole part 120, the output torque of the motor including the rotor core 110 according to an embodiment of the present disclosure may increase, and torque ripples may be reduced. FIG. 10 is graphs for illustrating comparison of vertical air gap magnetic flux density B_n in a vertical direction and tangential air gap magnetic flux density B_t between a structure without a through hole (i.e., a conventional rotor core structure) and a structure with a through hole (i.e., a rotor core structure according to an embodiment of the present disclosure). In FIG. 10, the torque ripple of the motor is represented as the product of the vertical air gap magnetic flux density B_n and the tangential air gap magnetic flux density B_t.

FIG. 10 shows that, according to an embodiment of the present disclosure, in both the vertical air gap magnetic flux density B_n and the tangential air gap magnetic flux density B_t, the primary component increases, and the output torque increases in comparison with the conventional rotor core structure without a through hole. In addition, according to an embodiment of the present disclosure, the total harmonic distortion (THD) slightly increases in the vertical air gap magnetic flux density B_n and greatly reduces in the tangential air gap magnetic flux density B_t so that the overall torque ripple reduces in comparing with the conventional rotor core structure without a through hole. The graph of FIG. 10 is verified with a finite element method (FEM).

Referring to FIG. 2, according to an embodiment of the present disclosure, the through hole 122 and the magnet embedding hole 121 may be spaced apart from each other. In other words, as shown in FIG. 2, an interval T1 may be formed between the through hole 122 and the magnet embedded hole 121. By forming the interval T1 between the through hole 122 and the magnet embedded hole 121, it is possible to easily secure rigidity of the rotor stack 111 and provide ease of punching the through hole 122.

For instance, a pair of through holes 122 may be provided. As shown in FIG. 2, a pair of through holes 122 may be provided between the outer surface of the pole part 120 and the magnet embedded hole 121 of the pole part 120. Further, according to an embodiment of the present discloser, the pair of through holes 122 may be formed to be symmetrical with respect to the straight line connecting the center of the rotor core 110 and the core (or center) of the magnet embedded hole 121. The interval T1 between the through hole 122 and the magnet embedded hole 121, the diameter of the through hole 122, and the interval between the through hole 122 and the straight dotted line of FIG. 2 may be varied to minimize the torque ripple of the motor according to various embodiments the present disclosure.

Referring to FIG. 3, according to an embodiment of the present disclosure, the through hole 122 may be formed to be inscribed, enclosed, or disposed in a circle 301 in which the magnet 130 is inscribed, enclosed or disposed. For example, “inscribe” may mean drawing one shape inside another, just touching but not crossing sides. The circle 301 is coaxial with the rotor stack 111. The circle 301 coaxial with the rotor stack 111 has a diameter smaller than that of the outer surface of the rotor stack 111 so that the interval T2 between the outer surface of the rotor stack 111 and the circle 301 in which the magnet 130 is inscribed can be constant, stable torque can be output, torque ripple can be reduced, and the rigidity of the rotor core 110 can be secured.

Referring to FIG. 4, according to an embodiment of the present disclosure, a protrusion or protruded portion 401 convexly protruding from neighboring normals of the outer surface of the pole part 120 may be formed on the outer surface of the pole part 120. In other words, the protrusion 401 may have a larger curvature than that of the outer surface of the rotor stack 111 shown in FIGS. 2 and 3, and the through hole 122 may be formed between the magnet embedding hole 121 and the outer surface of the protrusion 401. An interval T1 may be formed between the through hole 122 and the magnet embedded hole 121. According to an embodiment of the present disclosure, the protrusion or protruded portion 401 may reduce noise in the torque output from the motor and provide stable output.

Referring to FIG. 5, according to an embodiment of the present disclosure, the through hole 122 may be formed to be inscribed, enclosed or disposed in a circle 501 in which the magnet 130 is inscribed, enclosed or disposed. For instance, the through hole 122 has one point of contact with the virtual circle 501. The circle 501 is eccentric with respect to the rotor stack 111. In the embodiment shown in FIG. 5, a center of the circle 501 in which the through hole 122 is inscribed, enclosed or disposed is different from the center of the rotor stack 111. The structure of the FIG. 5 may further reduce torque ripples than the structure of FIG. 3 by forming the through hole 122 to be inscribed, enclosed or disposed in the circle 501 eccentric with respect to the rotor stack 111.

More specifically, according to the embodiment illustrated in FIG. 5, the circle 501 in which the through hole 122 is inscribed, enclosed, or disposed may be eccentric toward the magnet embedded hole 121 with respect to the rotor stack 111 (e.g. upward in FIG. 5). In other words, the center O_ε of the circle 501 in which the through hole 122 is inscribed, enclosed, or disposed is eccentric with respect to the center O_c of the rotor stack 111. For instance, the center O_ε of the virtual circle 501 is closer to the magnet embedded hole 121 than the center O_c of the rotor stack 111. Accordingly, the circle 501 in which the through hole 122 is inscribed, enclosed, or disposed according to the embodiment of FIG. 5 has a larger curvature than the circle 301 in which the through hole 122 is inscribed, enclosed, or disposed according to the embodiment of FIG. 3, so that torque ripples can further reduced.

Referring to FIG. 5, the interval or thickness between the circle 501 in which the through hole 122 is inscribed and the outer surface of the protrusion 401 of the pole part 120 may be constant. In other words, according to the embodiment of FIG. 5, the through hole 122 may be formed to be inscribed in the circle 501 in which the magnet 130 is inscribed and which is eccentric toward the magnet embedded hole 121 with respect to the rotor stack 111, the protrusion 401 convexly protruding from neighboring normals of the outer surface of the pole part 120 may be formed on the outer surface of the pole part 120, and the interval between the outer surface of the protrusion 401 and the circle 501 may be constant. For example, the outer surface of the protrusion 401 and the circle 501 may be parallel to each other. The protrusion 401 and the circle 501 in which the through hole 122 is Inscribed may have a concentric center O_ε which is eccentric with respect to the center O_c of the rotor stack 111. And, the interval T3 between the outer surface of the protrusion 401 and the circle 501 in which the through hole 122 is inscribed may be constant. In other words, the interval T1 between the through hole 122 and the magnet embedding hole 121 and the interval T3 between the through hole 122 and the outer surface of the protrusion 401 each may be constant. Therefore, it is possible to secure the rigidity of the rotor stack 111 and ease of punching the through hole 122 and to reduce torque ripples.

Referring to FIG. 6, the through hole 122 may be formed to communicate with, or be connected with, the magnet embedded hole 121. In other words, the through hole 122 may be formed between the magnet embedded hole 121 and the outer surface of the rotor stack 111, and the through hole 122 may have a portion open toward the magnet embedded hole 121 to communicate with the magnet embedding hole 121. Accordingly, the through hole 122 and the magnet embedded hole 121 may be integrated as one single hole structure having combination of a plurality of holes. Although FIG. 6 illustrates an embodiment in which the protrusion 401 is formed in the pole part 120, the through hole 122 may be formed to communicate with the magnet embedded hole 121 even when the protrusion 401 is not formed in the pole part 120. When it is required to secure a sufficient diameter of the through hole 122 in punching the through hole 122 between the magnet embedded hole 121 and the outer surface of the pole part 120 so as to increase output torque or reduce torque ripples, if the interval between the magnet embedded hole 121 and the through hole 122 is too small, the manufacturing process for punching may not be easy, and the rigidity of the rotor stack 111 may be deteriorated. Thus, it is possible to secure both the ease of the punching and the rigidity of the rotor stack 111 by forming the through hole 122 to communicate with, or be connected with, the magnet embedded hole 121.

FIG. 11 illustrates an average torque (Nm) and a torque ripple (%) according to a diameter D_hole of the through hole 122 according to an embodiment of the present disclosure. In other words, the structure is identical to the conventional structure if the diameter of the through hole 122 is 0. As shown in FIG. 11, when the diameter of the through hole 122 is about 0.7 mm, the average torque is maximized (i.e. increased by about 3.5%) while the torque ripple is minimized (reduced by about 38%) when the diameter of the through hole 122 is about 1.3 mm. As such, the diameter of the through hole 122 for maximizing the average torque may differ from the diameter of the through hole 122 for minimizing the torque ripple. An appropriate through hole diameter may be set depending on, e.g., the number of rotations, core material, processing limit, or yield safety factor and, if necessary, the through hole 122 and the magnet embedding hole 121 may be allowed to communicate with, or be connected to, each other.

Referring to FIG. 7, the rotor core 110 according to an embodiment of the present disclosure may further include a fixing member 710 that is inserted into the through hole 122 of the rotor core 110. The fixing member 710 has two opposite ends axially fixed to the magnet 130. The fixing member 710 is inserted into the through hole 122 and passes through a plurality of rotor stacks 111 stacked. As the fixing member 710 inserted in the through hole 122 is supported by the magnet 130 on two opposite sides of the fixing member 710 in the axial direction, the magnet 130 may be fixed to the magnet embedding hole 121. Further, as two opposite ends of the fixing member 710 are supported by the stacked rotor stacks 111 as well as by the magnet 130, the stacked rotor stacks 111 may be fixed.

In other words, the fixation of the stacked rotor stacks 111 and the fixation of the magnet 130 may simultaneously or mutually be performed or acted by the fixing member 710 to simplify the coupling process. Further, no physical deformation needs to be applied to the rotor stack 111, thereby preventing the deterioration of motor performance. No use of an adhesive leads to cost savings.

Further, according to an embodiment of the present disclosure, the fixing member 710 may be formed of a non-magnetic body. Therefore, the output torque of the rotor core 110 and the motor can be increased and the torque ripples can be reduced by the through hole 122.

To fixedly couple the stacked rotor core 110 and magnet 130 by the fixing member 710 inserted in the through hole 122, the fixing member 710 may include a load member 810 and a coupling member or coupler 820, which are described below.

In other words, the fixing member 710 may be press-fitted into the through hole 122. In other words, the fixing members 710 may press-fitted into the through holes 122 of the rotor stacks 111 stacked and aligned.

According to an embodiment of the present disclosure, the through hole 122 may be formed to communicate with, or be connected with, the magnet embedding hole 121, and the fixing member 710 may be supported by the magnet 130 through a portion where the through hole 122 and the magnet embedding hole 121 communicate with, or be connected with, each other. In other words, a portion of the fixing member 710 may protrude from the through hole 122 to the magnet embedding hole 121 through the portion where the through hole 122 and the magnet embedding hole 121 communicate, or are connected, and the protruding portion of the fixing member 710 may be press-fitted into the through hole 122 while being supported by the magnet 130. The magnet 130 may be fixed to the magnet embedded hole 121 by the force applied to the magnet 130 by the fixing member 710 while being press-fitted, and such a structure is described below in detail.

According to an embodiment of the present disclosure, a rotor core 800 may include a rotor stack 111 including a plurality of pole parts 120 each having a magnet embedded hole 121 where a magnet 130 is embedded and at least one through hole 122 formed between the magnet embedded hole 121 and an outer surface of the pole part 120 and a fixing member 710 inserted into the through hole 122 and having two opposite ends axially supported by the magnet 130.

Further, according to an embodiment of the present disclosure, there may be provided a motor including the rotor core 800. In other words, there may be provided a motor including a rotor core 800, a stator core receiving the rotor core 800 therein, and a rotating shaft fixedly coupled to the rotor core 800 to rotate along with the rotor core 110.

Referring to FIG. 8, the same features and matters as those in the above-described embodiments, such as the position of the through hole 122 and the shape of the outer surface of the pole part 120 are briefly described, and the description will focus primarily on the differences. Although FIG. 8 illustrates the rotor core 800 having a protrusion 401, the present disclosure is not limited thereto, and the protrusion 401 may not be provided at the pole part 120.

The fixing member 710 is inserted into the through hole 122, and two opposite ends of the fixing member 710 are axially supported by the magnet 130, and the magnet 130 is fixed with respect to the stacked rotor stacks 111. Accordingly, the fixation of the stacked rotor stacks 111 and the fixation of the magnet 130 may simultaneously or mutually be performed or acted by the fixing member 710 to simplify the coupling process. Further, no physical deformation needs to be applied to the rotor stack 111, thereby preventing the deterioration of motor performance. No use of an adhesive leads to cost savings.

According to an embodiment of the present disclosure, the fixing member 710 is formed of a non-magnetic body. Therefore, the output torque of the rotor core 800 and the motor can be increased and the torque ripples can be reduced by the through hole 122.

According to an embodiment of the present disclosure, a pair of through holes 122 may be provided in one pole part 120, and the fixing member 710 may be inserted into each through hole 122.

In other words, the fixing member 710 may be press-fitted into the through hole 122. The stacked rotor stacks 111 may be fixed by the coupling force provided to the stacked rotor stacks 111 by the fixing member 710 while being press-fitted and, as described below, the supporting force provided while two opposite ends of the fixing member 710 are supported on two axially opposite ends of the stacked rotor stacks 111.

According to an embodiment of the present disclosure, the through hole 122 may be formed to communicate with, or be connected with, the magnet embedded hole 121, and the fixing member 710 may be supported by the magnet 130 through a portion where the through hole 122 and the magnet embedded hole 121 communicate with, or are connected to, each other.

Referring to FIG. 9, the magnet 130 may be fixed in the magnet embedded hole 121 by the supporting force applied to the magnet 130 as the fixing member 710 is inserted into the through hole 122. In other words, according to an embodiment of the present disclosure, the through hole 122 may be formed to communicate with, or be connected with, the magnet embedding hole 121, and the fixing member 710 may be press-fitted into the through hole 122 while being supported by the magnet 130 through a portion where the through hole 122 and the magnet embedded hole 121 communicate with, or be connected with, each other. The fixing member 710 may be inserted into the through hole 122 communicating with, connected to, the magnet embedded hole 121 and simultaneously supported by the rotor stack 111 and the magnet 130 and, as the fixing member 710 is press-fitted into the through hole 122, a fixing force may be provided simultaneously to the magnet 130 inserted in the magnet embedded hole 121 and the stacked rotor stacks 111. Thus, the coupling process can be simplified. It should be noted that in FIG. 9, the portion of the fixing member 710 protruding through the portion where the through hole 122 and the magnet embedding hole 121 communicate is exaggerated for convenience of Illustration and understanding.

Referring back to FIG. 8, according to an embodiment of the present disclosure, the fixing member 710 may include a load member 810 including a body portion 811 inserted into the through hole 122 of the pole part 120 and a support 812 having a larger diameter than the body portion 811 at one end of the body portion 811 and supported by the magnet 130. In other words, the load member 810 may include the body portion 811 and the support 812, and the body portion 811 may be inserted or press-fitted into the through hole 122 of the pole part 120. As the body portion 811 is inserted or press-fitted and fixed in the through hole 122 of the pole part 120, the support 812 provided at one end of the body portion 811 is supported by the magnet 130. It is illustrated in the drawings that a pair of through holes 122 are provided at one pole part 120, and the load member 810 is inserted into each through hole 122 in the same axial direction. Alternatively, the two load members 810 may be inserted into the through holes 122 in different directions, the respective supports 812 of the load members 810 are supported on two axially opposite ends of the magnet 130 while axially fixing the magnet 130. For instance, one of the supports 812 of the pair of load members 810 may be disposed on the upper surface of the pole part 120, when the other of the supports 812 of the pair of load members 810 may be disposed on the lower surface of the pole part 120. Further, the supports 812 of the load members 810 inserted into the through hole 122 in different directions may be supported by the rotor stack 111 as well as by the magnet 130 and be fixed to the stacked rotor stacks 111.

According to an embodiment of the present disclosure, the fixing member 710 may further include a coupling member or coupler 820 supported by the magnet 130 and coupled to the other end of the body portion 811 which is an opposite end of the body portion 811 to an end of the body portion 811 where the support 812 is provided. In other words, the support 812 and the coupling member 820 may be provided on two opposite ends of the body portion 811, respectively, and the support 812 and the coupling member 820 may be supported on two axially opposite sides of the magnet 130 inserted in the magnet embedded hole 121, fixing the magnet 130. Further, the support 812 and the coupling member 820 may be supported by the rotor stack 111 as well as the magnet 130, fixing the stacked rotor stacks 111.

According to an embodiment, the coupling member 820 may be press-fitted over the other end of the body portion 811. In other words, after the load member 810 is inserted or press-fitted into the through hole 122 of the pole part 120, the coupling member 820 may be press-fitted over the other end of the body portion 811.

Therefore, the rotor core and the motor including the same according to some embodiments of the present disclosure described above can stably provide high output by increasing output torque and reducing torque ripples, simplify the process for stacking and coupling the magnet and the rotor, and reduce manufacturing costs.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A rotor core comprising a rotor stack including a plurality of pole parts, each pole part having a magnet embedded hole having a magnet therein and at least one through hole located between the magnet embedded hole and an outer surface of the each pole part.

2. A motor comprising the rotor core of claim 1.

3. The rotor core of claim 1, wherein the through hole and the magnet embedded hole are spaced apart from each other.

4. The rotor core of claim 1, wherein the at least one through hole located between the magnet embedded hole and the outer surface of the each pole part comprises a pair of through holes.

5. The rotor core of claim 4, wherein the pair of through holes are symmetrical to each other with respect to a straight line connecting a center of the rotor stack and a center of the magnet embedded hole.

6. The rotor core of claim 1, wherein the through hole located between the magnet embedded hole and the outer surface of the each pole part is positioned to be inscribed in a circle inscribing the magnet and being coaxial with the rotor stack.

7. The rotor core of claim 1, wherein a convex protrusion is formed on an outer surface of the each pole part.

8. The rotor core of claim 1, wherein the through hole located between the magnet embedded hole and the outer surface of the each pole part is positioned to be inscribed in a circle inscribing the magnet and being eccentric with respect to the rotor stack.

9. The rotor core of claim 8, wherein the circle inscribing both the through hole and the magnet is eccentric, toward the magnet embedded hole, with respect to the rotor stack.

10. The rotor core of claim 1, wherein:
the through hole located between the magnet embedded hole and the outer surface of the each pole part is positioned to be inscribed in a circle inscribing the magnet and being eccentric, toward the magnet embedded hole, with respect to the rotor stack,
a convex protrusion is formed on an outer surface of the each pole part, and
an interval between an outer surface of the convex protrusion and the circle inscribing both the through hole and the magnet is constant.

11. The rotor core of claim 1, wherein the through hole located between the magnet embedded hole and the outer surface of the each pole part is connected to the magnet embedded hole.

12. The rotor core of claim 1, further comprising a fixing member inserted in the through hole located between the magnet embedded hole and the outer surface of the each pole part, the fixing member having two opposite ends axially supported by the magnet.

13. The rotor core of claim 12, wherein the fixing member inserted in the through hole has a non-magnetic body.

14. A rotor core, comprising:
a rotor stack including a plurality of pole parts, each pole part having a magnet embedded hole having a magnet therein and at least one through hole located between the magnet embedded hole and an outer surface of the each pole part; and
a fixing member inserted in the through hole and axially supported by the magnet.

15. A motor comprising the rotor core of claim 14.

16. The rotor core of claim 14, wherein:
the at least one through hole located between the magnet embedded hole and the outer surface of the each pole part has a pair of through holes, and
the fixing member is inserted in each of the pair of through holes.

17. The rotor core of claim 14, wherein:
the through hole located between the magnet embedded hole and the outer surface of the each pole part is connected to the magnet embedded hole, and
the fixing member is supported by the magnet through a portion where the through hole and the magnet embedded hole are connected to each other.

18. The rotor core of claim 14, wherein:
the through hole located between the magnet embedded hole and the outer surface of the each pole part is connected to the magnet embedded hole, and
the fixing member is press-fitted in the through hole and supported by the magnet through a portion where the through hole and the magnet embedded hole are connected to each other.

19. The rotor core of claim 14, wherein the fixing member includes:
a load member including a body portion inserted in the through hole located between the magnet embedded hole and the outer surface of the each pole part, and
a support having a larger diameter than the body portion at one end of the body portion and supported by the magnet.

20. The rotor core of claim 19, wherein the fixing member further includes a coupler coupled to another end of the body portion and supported by the magnet.
